(19) United States
(12) Patent Application Publication
(10) Pub. No.: US 2026/0352060 A1
(43) Pub. Date: Nov. 5, 2026

(54) MOTOR GEARBOX CONTROL SYSTEM

(71) Applicant: ASIA VITAL COMPONENTS CO., LTD., New Taipei City (TW)

(72) Inventors: Kuo-Chen Chang, New Taipei City (TW); Chang-Jiang Qin, New Taipei City (TW); Xu-Chen Jin, New Taipei City (TW)

(21) Appl. No.: 19/240,118

(22) Filed: Jun. 17, 2025

(30) Foreign Application Priority Data
Apr. 30, 2025 (TW) 114116427

(51) Int. Cl. H02K 5/22; F16H 57/02; H02K 7/116; H02K 11/30

(52) U.S. Cl. CPC H02K 5/225; F16H 57/02; H02K 7/116; H02K 11/30; F16H 2057/02034; F16H 2057/02073

(57) ABSTRACT

A motor gearbox control system is provided herein and includes a motor gearbox housing and an expansion control unit. The motor gearbox housing includes an electric assembly disposed therein and the electric assembly includes at least one guide pin. The expansion control unit is disposed at a lateral side of the electric gear housing. The electric assembly is electrically connected to the expansion control unit by extending the at least one guide pin to the expansion control unit to reduce usage of wiring cables and fasten components.

This application claims the priority benefit of Taiwan patent application number 114116427 filed on Apr. 30, 2025, the disclosure of which is hereby incorporated by reference in its entirety.

### BACKGROUND OF THE INVENTION

### 1. Field of the Invention

The present disclosure is related to a motor gearbox, and more particularly to a motor gearbox control system capable of reducing components cost and installation procedures.

### 2. Description of the Related Art

A motor gear mechanism is a commonly used device. Since the motor gear mechanism can be implemented to reduce speed and increase torque, it has been widely applied in various fields, such as transportation tools like automobiles and ships, heavy machinery used in construction or engineering, robotic arm joints, rotating modules in robots and machine tools, and so on. In conventional technology, as shown in FIG. 1, the motor gear structure 10 primarily includes a connector interface 101. During operation, the motor gear structure 10 requires a connecting wire 11, which has connectors 111 at both ends, to establish connections. The connector 111 at one end of the connecting wire 11 must be plugged into the connector interface 101, and the connector 111 at the other end is connected to the Zone Control Unit (ZCU) circuit board 12. The ZCU circuit board 12 is then linked to the Electronic Control Unit (ECU) circuit board 14 via another connecting wire 13 to achieve the control of the motor gear structure 10. Accordingly, conventional technology requires additional connecting wires 11, connectors 111 and assembly procedures to connect to the ZCU circuit board 12. Furthermore, the ZCU circuit board 12 needs a designated fastening position and extra fastening components for securing in place. The additional connecting wires 11 and connectors 111 with the ZCU circuit board 12 will complicate configuration and arrangement to make modular setups more challenging. Additionally, the multi-stage electrical connections will increase the likelihood of failure points.

Therefore, in order to solve aforementioned problems, how to reduce the increasing of the assembly costs caused by the cost of components setup and the complexity of assembly procedures required for multi-stage electrical connections in the motor gear mechanism 10 is a key direction of research and improvement pursued by the inventor in the present disclosure and relevant industry manufacturers.

### SUMMARY OF THE INVENTION

It is therefore a primary object of the present disclosure to provide a motor gearbox control system capable of reducing component setup costs as well as assembly procedures and assembly costs.

It is another object of the present disclosure to provide a motor gearbox control system capable of minimizing contact degradation and lowering failure rates.

It is a further object of the present disclosure to provide a motor gearbox control system capable of enabling modular configuration.

To achieve the above and other objects, a motor gearbox control system is provided herein and includes a motor gearbox housing and an expansion control unit. The motor gearbox housing includes an electric assembly disposed therein and the electric assembly includes at least one guide pin. The expansion control unit is disposed at a lateral side of the electric gear housing. The electric assembly is electrically connected to the expansion control unit by extending the at least one guide pin to the expansion control unit to reduce usage of wiring cables and fasten components.

Through the motor gearbox control system in the present disclosure, the expansion control unit is installed on one side of the motor gearbox housing and is directly and electrically connected to the internal guide pin extending from the electric assembly. This design effectively reduces the number of connection wires and connectors between the motor gearbox housing and the expansion control unit. Additionally, it minimizes the need for separately configured circuit board locking positions, extra locking components, and complex assembly procedures, which simplifies installation and layout configuration. Furthermore, it helps reduce contact degradation and failure rates caused by wiring and connectors.

### BRIEF DESCRIPTION OF THE DRAWINGS

The structure and the technical means adopted by the present disclosure to achieve the above and other objects can be best understood by referring to the following detailed description of the preferred embodiments and the accompanying drawings, wherein:

FIG. 1 is a schematic diagram in prior art;

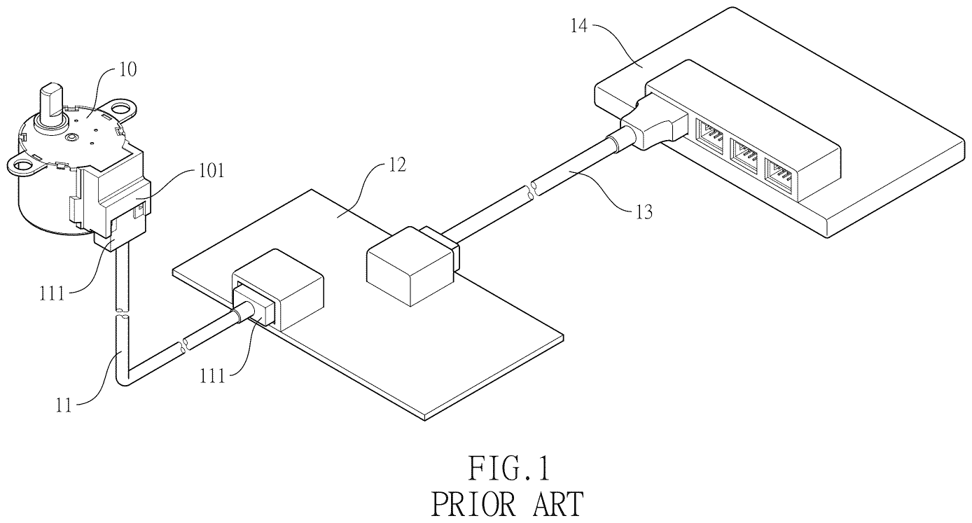

FIG. 2 is a three-dimensional (3D) assembly schematic diagram of a motor gearbox controlling system in the present disclosure;

FIG. 3 is a 3D exploded diagram of a motor gearbox controlling system in the present disclosure;

FIG. 4 is a 4-4 cross-sectional diagram of FIG. 2; and

FIG. 5 is a 3D assembly schematic diagram of the motor gearbox control system connecting to the regional control unit.

### DETAILED DESCRIPTION OF THE PREFERRED EMBODIMENTS

The technical characteristics, features and advantages of the present disclosure will become apparent in the following detailed description of the preferred embodiments with reference to the accompanying drawings.

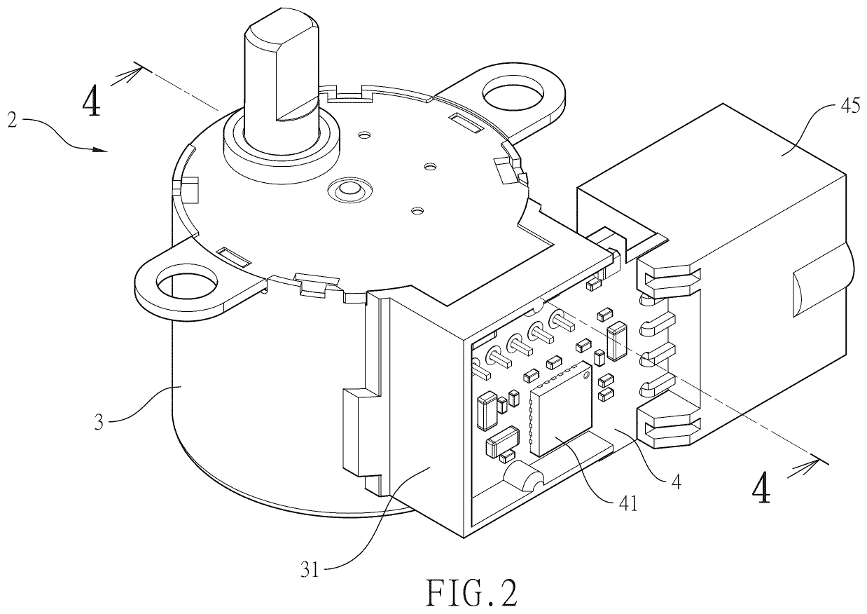

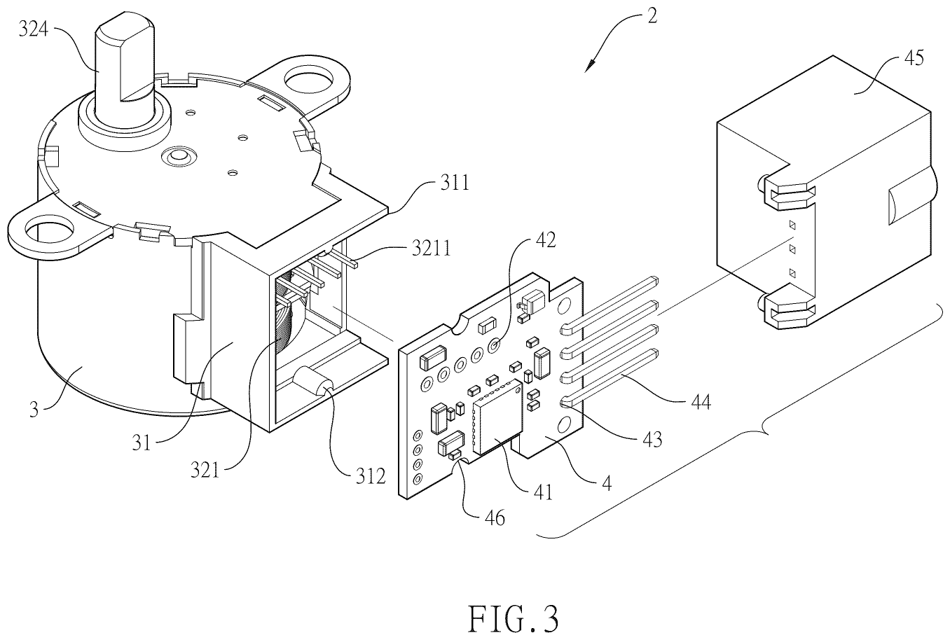

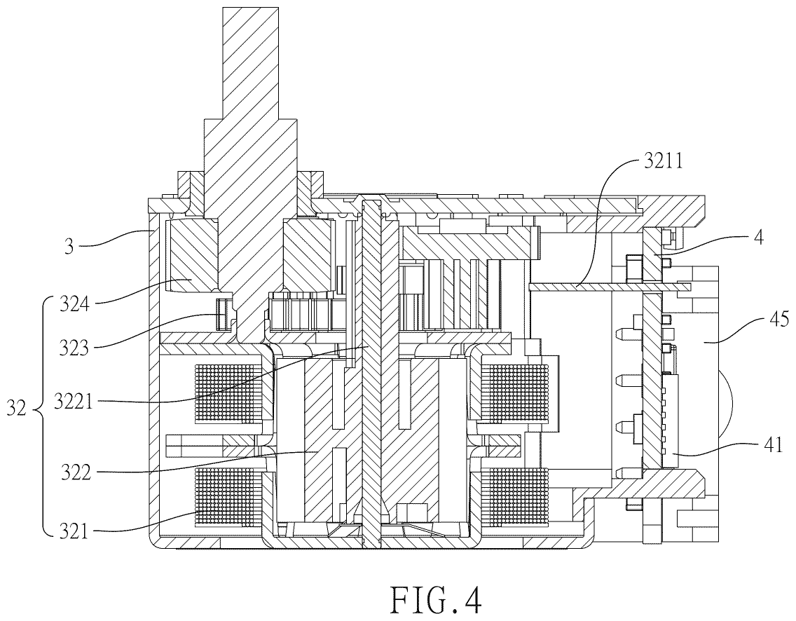

Please refer to FIGS. 2, 3 and 4, FIG. 2 is a three-dimensional (3D) assembly schematic diagram of a motor gearbox controlling system in the present invention, FIG. 3 is a 3D exploded diagram thereof and FIG. 4 is a 4-4 cross-sectional diagram of FIG. 2. As shown in FIGS. 2, 3 and 4, the motor gearbox control system 2 includes a motor gearbox housing 3 and an extension control unit 4.

The motor gearbox housing 3 is formed of a top cover and a bottom cover, and a fixed box 31 is formed at a lateral side of the motor gearbox housing 3. The fixed box 31 has a lateral opening 311 formed at the lateral side of the fixed box 31. The motor gearbox housing 3 includes an electric assembly 32 disposed within the motor gearbox 3. The electric assembly 32 includes a stator set 321, a rotor set 322, a gear set 323 and an output gear shaft 324. In the present embodiment, the stator set 321 is disposed within the motor gearbox housing 3 and includes a plurality of internal guide pins 3211. The internal guide pins 3211 can be guidance pins, and the internal guide pins 3211 are entered into the fixed box 31 through the motor gearbox housing 3. The rotor set 322 is disposed within the stator set 321, and a rotor gear shaft 3221 is protruded on top of the rotor set 322. The gear set 323 is installed on top of the stator set 321 and is pivotally connected to the rotor gear shaft 3221. In addition, the output gear shaft 324 is disposed on top of the gear set 323. The output gear shaft 324 is pivotally connected to the rotor gear shaft 3221, and the top portion of the output gear shaft 324 is protruded outside of the motor gearbox housing 3. The arrangement and positioning relationship of the stator set 321, the rotor set 322, the gear set 323 and the output gear shaft 324 are not limited herein. The transmission mechanism within the electric assembly 32, for example, the rotor set 322 is rotated by driving the stator set 321, the rotor set 322 drives the gear set 323 to move, and the gear set 323 drives the output gear shaft 324 to rotate, can be the embodiment of the electric assembly 32 in the present embodiment.

The expansion control unit 4 is installed within the fixed box 32, which is at the lateral side of the motor gearbox housing 3, and the expansion control unit 4 is protruded from the lateral opening 311. There is an expansion control chip 41 welded on the expansion control unit 4 and the expansion control chip 41 is a Zone Control Unit (ZCU). Multiple electric connecting through holes 42 are formed on top of the expansion control unit 4. The electric connecting through holes 42 are connected to the internal guide pins 3211, so the electric assembly 32 is electrically connected to the expansion control unit 4. Multiple expansion openings 43 are further formed in the extension control unit 4. The expansion openings 43 are formed on an external position of the expansion control unit 4 passing the lateral opening 311, and at least one expansion guide pin 44 or connecting point (golden finger) is disposed at the expansion opening 43. The expansion guide pin 44 is bent from the expansion opening 43 toward one side and horizontally extended. The expansion control unit 4 is connected to an expansion connector 45 via the expansion guide pin 44. The interface of the expansion connector 45 is formed on the side opposite to the expansion guide pin 44.

As mentioned above, at least one rib 312 is formed on the inner sidewall of the fixed box 31. A groove 46 is formed at the position of the expansion control unit 4 corresponding to the rib 312 inside the fixed box 31. The expansion control unit 4 is positioned on the rib 312 via the groove 46 to ensure that the expansion control unit 4 is securely located within the fixed box 31 and relatively located at the lateral side of the motor gearbox housing 3.

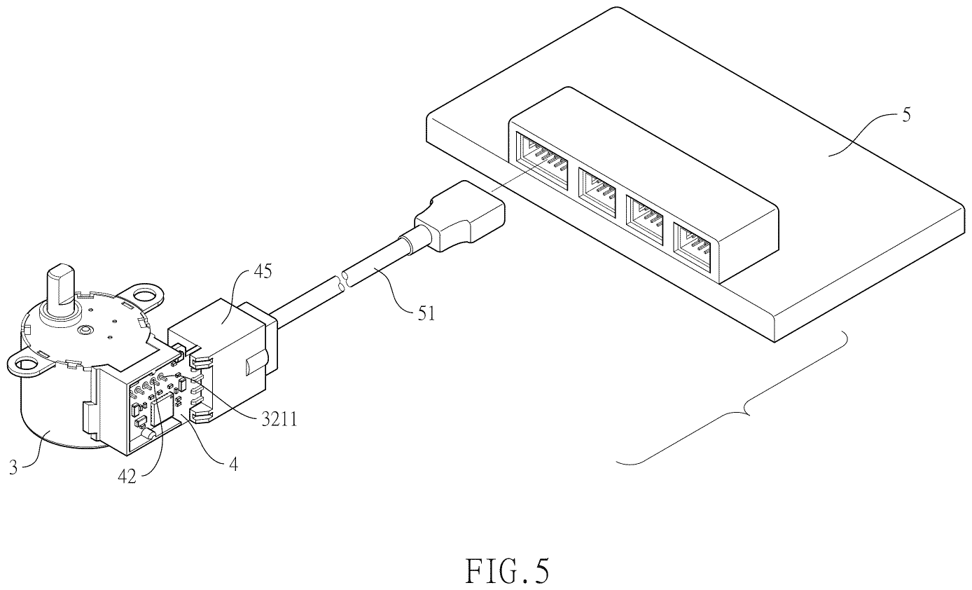

Please refer to the aforementioned figures and FIG. 5, and FIG. 5 is a 3D assembly schematic diagram of the motor gearbox control system connecting to the regional control unit. The expansion control unit 4 is installed inside the fixed box 31 on one side of the motor gearbox housing 3. The internal guide pin 3211 passes through the electric connecting through hole 42 and is electrically connected to the expansion control unit 4. Thereafter, the expansion connector 45 on the expansion control unit 4 is able to be connected to the regional control unit 5 via an expansion cable 51 to enable the regional control unit 5 to be electrically connected to the expansion control unit 4 as so to achieve the control of the electric assembly 32.

Accordingly, in the motor gearbox control system 2 of the present disclosure, the expansion control unit 4 is directly installed on the side of the motor gearbox housing 3. The internal guide pin 3311 of the motor assembly 32 passes through the motor gearbox housing 3 and is directly electrically connected to the expansion control unit 4. The aforementioned design effectively reduces the number of connection wires and connectors between the motor gearbox housing and the expansion control unit, minimizes the need for additional locking positions for the circuit board, and reduces the installation complexity associated with extra locking elements and procedures, thereby simplifying assembly and layout configurations.

Additionally, by reducing the configuration of connectors and wiring contact points, the likelihood of contact degradation and failure caused by wiring and connectors is relatively reduced. Furthermore, the motor gearbox control system 2 can be modularly configured within the equipment.

Based on the above description, the present disclosure has the following advantages compared to conventional designs:
(a) reduces component setup costs as well as assembly procedures and assembly costs.
(b) minimizes contact degradation and lowers failure rates.

### (c) Enables Modular Configuration.

The present disclosure has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A motor gearbox control system comprising:
a motor gearbox housing including an electric assembly disposed therein and the electric assembly including at least one guide pin; and
a expansion control unit disposed at a lateral side of the electric gear housing;
wherein the electric assembly is electrically connected to the expansion control unit by extending the at least one guide pin to the expansion control unit to reduce usage of wiring cables and fasten components.

1. The motor gearbox control system as claimed in claim 1, wherein the expansion control unit is disposed within a fixed box located at the lateral side of the motor gearbox housing, and the internal guide pin is connected to the expansion control unit through the fixed box.

2. The motor gearbox control system as claimed in claim 2, wherein the expansion control unit is configured to include an expansion control chip and an expansion connector, and the expansion control unit is connected to a regional control unit via the expansion connector.

3. The motor gearbox control system as claimed in claim 1, wherein the expansion control unit includes a plurality of electric connecting through holes formed thereon and the internal guide pin is passing through the electric connecting through holes to be connected to the expansion control unit.

4. The motor gearbox control system as claimed in claim 1, wherein the electric assembly includes a stator set and a rotor set, and the stator set includes the internal guide pin and the rotor set is disposed within the stator set and having a rotor gear shaft protruded at one side thereof.

5. The motor gearbox control system as claimed in claim 5, wherein the electric assembly further includes a gear set, and the gear set is disposed on top of the stator set and pivotally connected to the rotor gear shaft.

6. The motor gearbox control system as claimed in claim 6, wherein the electric assembly further includes an output gear shaft, and the output gear shaft is disposed on top of the gear set and is pivotally connected to the gear set, and one end of the output gear shaft is protruded outside of the motor gearbox housing.

7. The motor gearbox control system as claimed in claim 2, wherein the fixed box includes at least one rib formed on an inner sidewall of the fixed box, and at least one groove is formed on the lateral side of the expansion control unit and mutually assembled to the at least one rib.

8. The motor gearbox control system as claimed in claim 3, wherein the expansion unit includes an expansion through hole for at least one expansion guide pin disposed therein, and the expansion control unit is connected to the expansion connector via the at least one expansion pin.

9. The motor gearbox control system as claimed in claim 9, wherein the fixed box includes a lateral opening formed at one side of the fixed box and the at least one expansion guide pin is horizontally extended from the lateral opening, then the expansion control unit is able to be connected to the expansion connector via the at least one expansion guide pin.
